(19) United States
(12) Patent Application Publication
(10) Pub. No.: US 2004/0117690 A1
(43) Pub. Date: Jun. 17, 2004

(54) Method and apparatus for using a hardware disk controller for storing processor execution trace information on a storage device

(76) Inventor: Anders J. Andersson, San Jose, CA (US)

Correspondence Address: SCHNECK & SCHNECK, P.O. BOX 2-E, SAN JOSE, CA, 95109-0005, US

(21) Appl. No.: 10/361,128

(22) Filed: Feb. 5, 2003

Related U.S. Application Data
(60) Provisional application No. 60/433,493, filed on Dec. 13, 2002.

(51) Int. Cl. H04B 1/74

(52) U.S. Cl. 714/45

(57) ABSTRACT

A system and method for recording a test device's execution flow. The device under test is connected to a programmable hardware recording unit, or disk controller, with a cache memory. Output from the test device, representing the test device's execution flow, is written to a cache memory at the hardware recording unit. Data from the cache memory at the hardware recording unit is drained from the cache memory and written to a large capacity, non-volatile storage device. Execution trace data stored at the storage device may subsequently be reviewed to identify any problems that occurred while the test device was operating.

### CROSS-REFERENCE TO RELATED APPLICATION

This application claims priority from U.S. provisional application No. 60/433,493, filed Dec. 13, 2002.

### TECHNICAL FIELD

The invention relates to electronic apparatus for controlling magnetic disk drives and capturing a test device's execution trace.

### BACKGROUND OF THE INVENTION

When an electronic apparatus incorporating a device, for example, a processor, such as a microcontroller, or a regulator, or sequencer is undergoing regression or field testing, it is often difficult to identify, understand, and remedy any problems that may occur during testing. This is due to the fact that the trace length in emulation trace or logic analysis is typically less than a second and requires a trigger be set on an event that causes or indicates failure. However, during regression or field testing, it is assumed that the device has already been debugged and therefore no triggers can be set since there are no expected failure events. Therefore, it would be valuable to be able to record a test device's execution trace for an extended period of time in order to review the trace to determine where problems originate and how they may be fixed. Even if no problems occur, a review of how the flow of the program interacts with data can provide valuable insights to how the program functions.

U.S. Pat. Nos. 6,314,530 (“Processor Having a Trace Access Instruction to Access On-Chip Memory”), 6,167,536 (“Trace Cache for a Microprocessor-Based Device”), and 6,094,729 (“Debug Interface Including a Compact Trace Record Storage”), all assigned to Advanced Micro Devices, Inc., teach a processor with an on-chip trace memory that stores information relating to certain executable threads or conditions. The trace data stored in the cache is compressed. A trace access instruction is executed to access the on-chip trace memory on the processor. The approach in these patents is not suitable for regression testing since the trace memory is relatively small and requires a trigger to be set.

U.S. Pat. No. 6,243,836 “Apparatus and Method for Circular Buffering on an On-Chip Discontinuity Trace,”0 assigned to Lucent Technologies, Inc., discloses a method and apparatus for providing “trace until” capability (i.e., tracing until an event occurs rather than only being able to collect a trace for a finite duration from a specified starting point) by circular buffering of a JTAG bit stream consisting of a compressed program trace. A developer sets a trace trigger on the memory address that halts execution. The trace is collected in a circular buffer until the trigger fires. The program is then reconstructed using information stored in the circular buffer. Like the patents listed above, this approach requires a trigger to be set and is therefore not suitable for regression testing.

U.S. Pat. No. 5,884,023 “Method for Testing an Integrated Circuit with User Definable Trace Function,” assigned to Texas Instruments, Inc., discloses a method for tracing data where information is stored in a trace buffer on the processor being tested and eventually transferred to the host processor; both storage and transfer of information is under the control of a user-definable program which is executed in response to trigger events. As noted above, approaches requiring triggers to be set are not suitable for regression testing.

U.S. Pat. No. 5,724,505 “Apparatus and Method for Real-Time Program Monitoring Via a Serial Interface,” assigned to Lucent Technologies, discloses a digital microprocessor that has trace recording hardware. This trace recording hardware receives data indicative of instruction types and program addresses from the processor. When a particular, predefined instruction type is recognized by a trace buffer control, the instruction and the associated address are stored in FIFO buffers. The program trace information is compressed and sent to the host computer.

U.S. Pat. No. 5,944,841 “Microprocessor with Built-In Instruction Tracing Capability,” assigned to Advanced Micro Devices, discloses a computer system, including memory and a CPU, with an instruction tracing mechanism. The patent discloses a processor with control unit which activates instruction tracing by retrieving a special tracing sequence to provide a trace of instructions passed to the instruction decoder from the CPU.

None of the prior art discussed above allows for all of a test device's execution flow information to be stored in real time. This is due to two factors. The first is that storing execution flow in its entirety requires enormous storage capacity. The second limiting factor is speed. Microcontrollers can output data at a rate of 100 megabytes per second. Software controlling writes to storage devices, such as a hard disk drive which has the storage capacity to store execution flow in its entirety, writes to memory at a rate of 10-20 megabytes per second. Since software cannot write to memory at a rate equal to a microcontroller's output rate, data will be lost. What is required, then, is an approach which combines large storage capacity with the ability to write to memory very quickly.

It is an object of this invention to provide a method and apparatus for recording a device's execution flow that can store device execution flow information in real time.

It is another object of this invention to provide a method for reviewing a device's execution flow.

### SUMMARY OF THE INVENTION

The invention is a method and apparatus for storing execution trace data from a device under test such as a processor, for instance, a microcontroller, or a sequencer or regulator, to a large capacity, non-volatile storage device, such as a hard disk drive or a flash memory. A programmable hardware recording unit, or disk controller, with a high clock speed which is in electrical connection with the device under test contains a cache memory with an input pointer and an output pointer as well as other logic. The hardware disk controller is also in connection with the storage device. The test device's execution trace is written to the hardware recording unit's cache memory. The data in the cache memory is drained and written to the storage device. Since data is written to the cache memory and the storage device by hardware rather than software, no data is lost despite the fact that the test device can output data at at least a rate of 100 megabytes per second. Depending on the sustained rate and width of information coming out of the device under test, more than one disk drive may be needed to keep up with the oncoming data.

Information recorded to the storage device at the end of a recording includes the “event pointer memory,” the “in/out pointer memory,” and the “last disk sector pointer.” This information is transferred from the disk controller to the storage device at the end of recording. In one embodiment of the invention, hardware recording units may be stacked so that wide bit streams may be recorded; this arrangement also further enables high speed recording. After recording the execution trace to the storage device, the storage device can then be queried to examine long periods of execution trace.

### BRIEF DESCRIPTION OF THE INVENTION

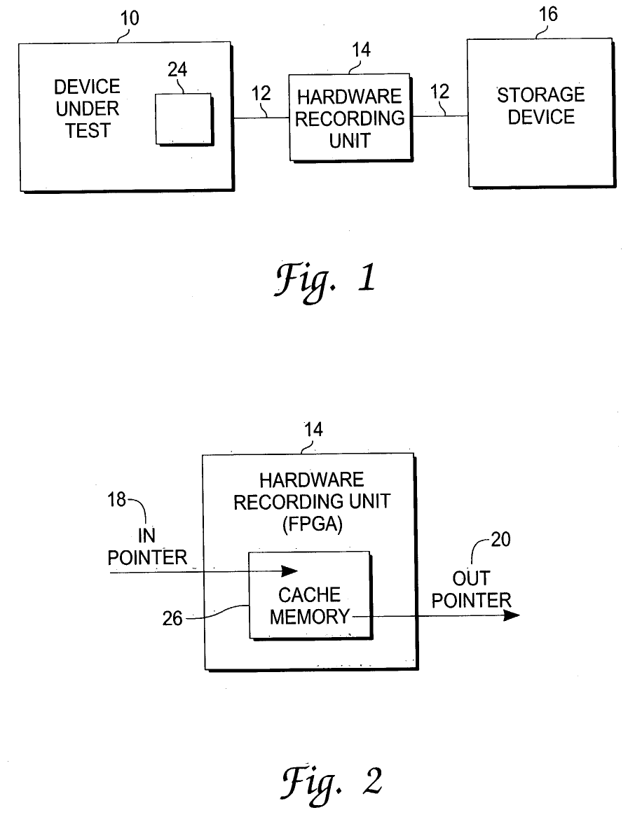

FIG. 1 is a block diagram of a system for storing execution flow data to a storage device.

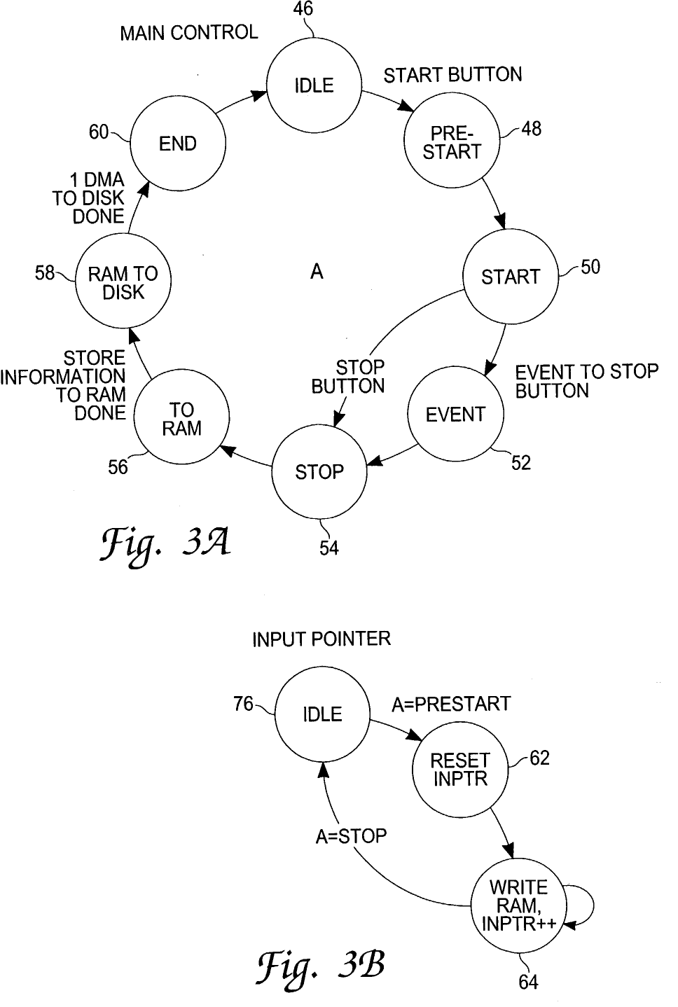

FIG. 2 is a block diagram of the hardware recording unit shown in FIG. 1.

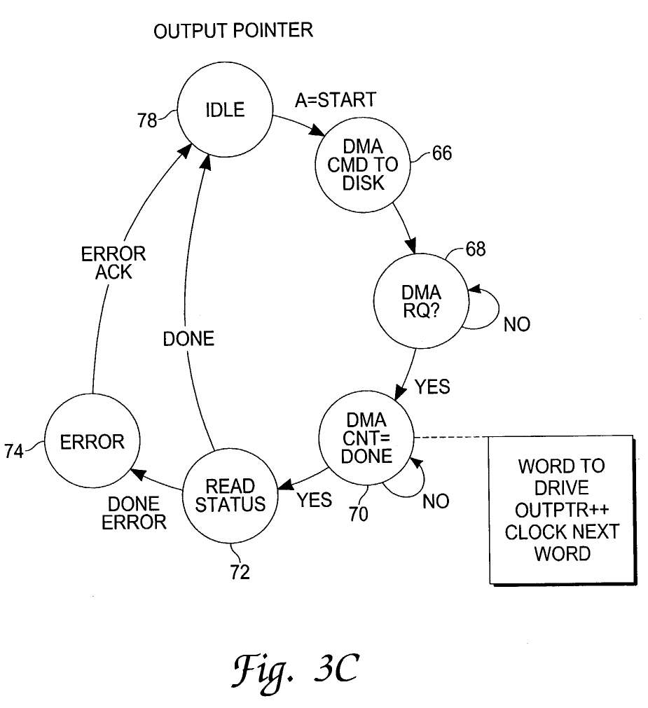

FIG. 3a is a state diagram for the state machine at the hardware recording unit shown in FIG. 1.

FIG. 3b is a state diagram for the input pointer at the hardware recording unit shown in FIG. 1.

FIG. 3c is a state diagram for the output pointer at the hardware recording unit shown in FIG. 1.

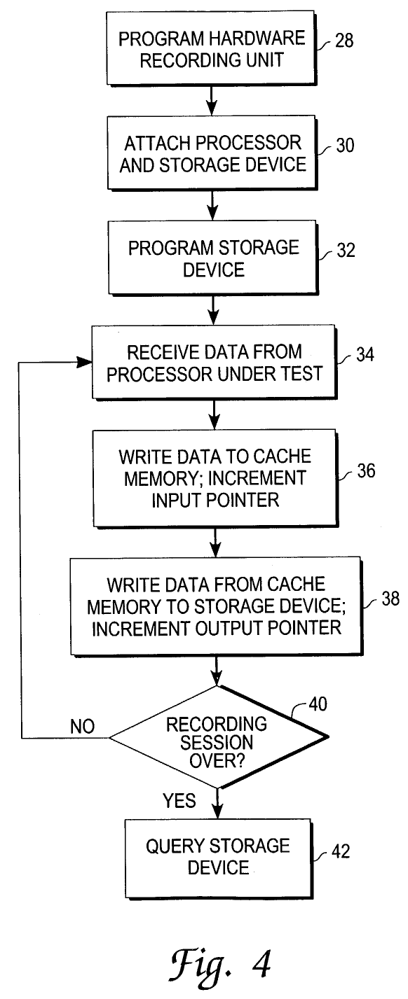

FIG. 4 is a flow chart showing how a test device's execution trace data is stored at separate storage device.

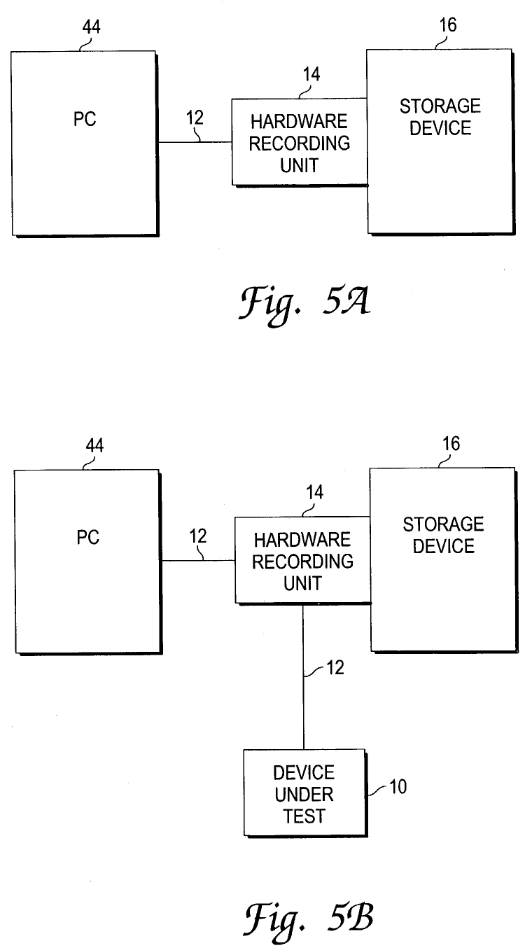

FIG. 5a is a block diagram showing one embodiment for querying a storage device storing execution trace data.

FIG. 5b is a block diagram showing another embodiment for querying a storage device storing execution trace data.

### DETAILED DESCRIPTION

With respect to FIG. 1, an apparatus 10 includes a device under test such as a processor 24, for instance, a microcontroller, which is electrically connected 12 to a hardware recording unit 14. (In other embodiments, the device under test may be a sequencer or regulator.) The hardware recording unit 14 is also connected to a large capacity, non-volatile storage device 16, such as a hard disk drive or a flash memory. As will be described in greater detail below, execution trace data from the processor 24 is temporarily stored by the hardware recording unit 14 and then written to the storage device 16. The processor 24 may output data at the rate of at least 100 megabytes per second while the hardware recording unit 14 may write to the storage device's 16 magnetic media at a rate of at least 40 megabytes per second. (At the time of writing, processors can output data at a rate of 3×100 Mbyte/sec if no compression is used.) All accesses by the hardware recording unit 14 to the storage device 16 are performed by hardware, so throughput of data is not degraded, and data is not lost, as it would be if software, which can write to memory at a rate of 10-20 megabytes per second, performed the write to the storage device 16.

Referring to FIG. 2, the hardware recording unit 14 contains a cache memory 26, or circular buffer. The cache memory 26 features an input pointer 18 as well as an output pointer 20. The input pointer 18 maintains the input position in the cache memory 26 while the output pointer 20 maintains the readout position from the cache memory 26.

The hardware recording unit, or disk controller, may be a Field Programmable Gate Array (FPGA) or a Complex Programmable Logic Device (CPLD), that can clock at very high speed. In these devices, the logic network can be programmed into the device after its manufacture. In one embodiment the hardware recording unit may be mounted on a printed circuit board that is plugged into the storage device and which will allow a connection to the device under test.

The hardware recording unit is programmed by software to fit a certain test device output interface and to act as a disk controller. As noted above, the hardware recording unit contains a cache memory as well as an input and output pointer for the cache memory. In addition, the hardware recording unit contains logic for receiving data from the test device and writing it to the cache memory in conjunction with the input pointer and logic for draining data from the cache memory and writing it to the storage device in conjunction with the output pointer.

Included in this logic is a hardware state machine that works with the output pointer to program the storage device to receive data from the hardware recording unit. This state machine handles all the accesses to the storage device's control registers to program appropriate commands (read/write/erase, etc.) for handling data written to the storage device by the hardware recording unit. Once these commands are programmed, the hardware unit's logic takes data from the cache memory (as indicated by the output pointer) and writes it to the storage device's data registers.

The hardware recording unit also contains logic that maintains and monitors the distance between the input pointer and the output pointer as these pointers enter and remove data from the cache memory. The input pointer is incremented as execution trace information is written to the cache memory. Similarly, the output pointer is incremented as execution trace information is removed from the cache memory and written to the storage device.

In one embodiment, the storage device may contain a cache memory. This second cache memory can buffer a burst of data written to the storage device while the disk controller writes the data to the magnetic storage media in the storage device.

With respect to FIG. 3a, the main control state machine “A” is initially in an IDLE state (block 46). The state machine shifts to a PRE-START state (block 48) and to a START state (block 50) when the appropriate signal (for example, the user pushing a “start button”) is received. The state machine then enters the EVENT state (block 52), here, capturing and writing the execution trace from the test device. The state machine may enter the STOP state (block 54) either by the user issuing a stop signal (for example, pushing a “stop button”) or when the EVENT state (block 52) terminates (for instance, the end of recording). Once the state machine is in the START state (block 50), both the input pointer (“inptr”) and output pointer (“outptr”) are working to write data to or drain data from the cache memory.

Referring to FIG. 3b, the input pointer is initially IDLE (block 76). When the main control state machine “A” is at PRESTART, the input pointer is RESET (block 62). As data is received, it is written to RAM (the cache memory) and the input pointer is incremented (block 64). When the main control state machine “A” is at STOP, no data is received and the input pointer is IDLE (block 76).

In FIG. 3c, the output pointer is also initially IDLE (block 78). When the main control state machine “A” is at START, the output pointer programs direct memory access (DMA) commands for handling data written to the storage device (block 66). When there is a DMA REQUEST (block 68) (for instance, writing data to the storage device), the data is written to the storage device, the output pointer is incremented, and the next word is clocked (block 70). When there are no longer any DMA requests, the status of the cache memory is checked to determine that all data has been drained from the cache memory (block 72) and the output pointer returns to the IDLE state (block 78). If an error is detected (block 74), the output pointer also returns to the IDLE state (block 78).

Referring again to FIG. 3a, once the main control state machine “A” is at STOP (block 54), indicating that the recording period has ended, several other pieces of data are written to the cache memory (block 56) and then transferred to the storage device (block 58). This information includes the event pointer memory, which indicates certain events tagged by a user, the input/output pointer memory, and the last disk sector pointer which indicates the last sector of the storage device that was written to and therefore indicates the stopping point of the recording session. This information is written to a dedicated sector on the storage drive. Once the information is written to disk (block 58), the trace-recording process has ended (block 60) and the state machine returns to IDLE (block 46).

The process of recording execution trace data from a device under test, in this embodiment a processor, is shown in FIG. 4. The hardware recording unit is programmed with a bit stream to write data received from the test device into the cache memory and to write data stored in the cache memory to a storage device (block 28). The device under test, as well as the cache memory, are connected to the hardware recording unit (as noted above, the hardware unit may be mounted on a printed circuit board that is plugged into the storage device and which allows a connection to the device under test) (block 30).

The state machine in the hardware recording unit then programs the storage device to accept data as a sequence of words from the hardware recording unit (block 32). (In another embodiment, the storage device, for example, a disk drive, may be configured to receive data as a serial bit stream.) Once the storage device has been programmed, data may be written to it.

As the processor under test executes instructions, a bit flow of data representing the execution trace is received at the hardware recording unit (block 34). This received data is written to the hardware unit's cache memory; as the data is written to the cache memory, the input pointer tracking the input position in the cache memory is incremented (block 36). Data is drained from the cache memory and written to the storage device; as the data is written to the storage device, the output pointer maintaining the readout position from the cache memory is incremented (block 38). The distance between the input and output pointers is maintained by the hardware recording unit to ensure that no data is lost. As noted above, data is written to the storage device by hardware, not software. Data is written to the cache memory and the storage device for the length of the recording session (block 40). At the end of the recording session, event pointer memory, in/out pointer memory, and last disk sector pointer are also written to the storage device.

Once the recording session is over (block 40), the data stored at the storage device may be queried (block 42). The query can occur at any time since the non-volatile memory in the storage device will retain the data even after power is turned off.

With reference to FIGS. 5a and 5b, there are at least two potential embodiments which would allow the storage devices to be queried. In FIG. 5a, a standard desktop computer, or PC, 44 may be linked 12 to the storage device 16 in order to query the data after the storage device 16 and the hardware recording unit 14 have been detached from the device under test. In FIG. 5b, the PC 44 may be linked 12 to the storage device 16 while the storage device 16 and hardware recording unit 14 are still attached 12 to the device under test 10. Debugger software installed at the PC 44 would provide rapid search and display options for reviewing the data stored at the storage device 16.

In another embodiment of the invention, the user may stack recording units in order to record wide bit streams or to further support high speed recording. Each stacked unit knows its unit number. Unit 0 shows a “0” to unit 1, unit 1 shows a “1” to unit 2, etc. By using this approach, the recording/queried unit can maintain its information with reference to other units.

The system and process for recording execution trace data described in FIGS. 1, 2, 3a, 3b, 3c, and 4 above can sustain a data flow of roughly 100 megabytes per second for a period of half an hour using stacked units. The size of the prior art's maximum recording buffers have been around 1,000,000 trace frames—the approach described above increases storage capacity by a factor of about 100,000.

Different embodiments will allow recording time to exceed half an hour. In one embodiment, more than one storage device may be recorded to. In another embodiment, if message-driven technology controls the processor's execution flow, recording time can exceed half an hour since the processor's output is reduced. By using filtering, i.e., configuring the processor to output only certain messages, recording time can be extended even further.

1. A method for storing device execution trace in real time comprising:
a) receiving a bit flow of data representing the totality of execution trace data output by the device;
b) writing the bit flow as it is received to a cache memory at a separate hardware device;
c) draining the cache memory of stored bits; and
d) writing the stored bits drained from the cache memory to at least one storage device, the writing performed by hardware at the separate hardware device.

2. The method of claim 1 further comprising writing the stored bits drained from the cache memory to a second cache memory at the at least one storage device.

3. The method of claim 2 wherein bits are written to the at least one storage device while bits in the second cache memory are buffered.

4. The method of claim 1 further comprising programming the at least one storage device to receive the bits from the cache memory.

5. The method of claim 1 further comprising querying the at least one storage device after data has been recorded.

6. The method of claim 1 further comprising configuring the processor to output only certain messages.

7. The method of claim 1 further comprising configuring the separate hardware device to receive the bit flow data from the device.

8. The method of claim 1 further comprising configuring the separate hardware device to write stored bit flow data from the cache memory to the at least one storage device.

9. The method of claim 1 further comprising writing the bit flow to more than one hardware device.

10. The method of claim 1 further comprising writing an event pointer memory, an input/output memory, and a last disk sector pointer to the at least one storage.

11. A system for storing device execution trace comprising:
a) a device being tested, the test device producing a bit flow of data representing the totality of execution trace data output by the test device;
b) at least one storage device having memory; and
c) at least one hardware disk controller intermediating in electrical connection between the test device and the at least one storage device, the hardware disk controller receiving bit flow data from the test device, buffering the bit flow data in a first cache memory, and writing the received bit flow data to the at least one storage device.

12. The system of claim 11 further comprising the first cache memory having a first pointer for maintaining the input position in the first cache memory.

13. The system of claim 11 further comprising the first cache memory having a second pointer for maintaining the readout position from the first cache memory.

14. The system of claim 13 further comprising a hardware state machine that performs additional reads and writes to the at least one storage device to program the at least one storage device to receive data as a sequence of words.

15. The system of claim 12 further comprising a first circuit in electrical connection with the first data pointer for writing bit flow data received from the test device to the first cache memory.

16. The system of claim 13 further comprising a second circuit in electrical connection with the second data pointer for writing bit flow data stored in the first cache memory to the storage device.

17. The system of claim 16 further comprising a second circuit in electrical connection with the second data pointer for writing bit flow data stored in the first cache memory to the storage device.

18. The system of claim 11 further comprising the at least one storage device having a second cache memory for buffering data before it is written to the at least one storage device.

19. The system of claim 11 further comprising the test device outputting only certain predetermined messages.

20. The system of claim 11 further comprising means for querying stored data.

21. The system of claim 11 wherein the hardware disk controller is a FPGA.

22. The system of claim 11 wherein the hardware disk controller is a CPLD.

23. The system of claim 11 wherein the test device is one of:
a) a processor;
b) a sequencer; and
c) a regulator.

24. The system of claim 11 further comprising the hardware disk controller mounted on a printed circuit board.

25. The system of claim 24 further comprising the printed circuit board having connection means for the processor.

26. The system of claim 24 further comprising the printed circuit board having connection means for the storage device.

27. The system of claim 11 wherein the storage device is a hard disk drive.

28. The system of claim 11 wherein the storage device is a flash memory.

29. A hardware disk controller comprising:
a) a cache memory for storing bit flow data representing the totality of execution trace data output by a test device in electrical connection with the hardware disk controller;
b) a first data pointer for maintaining the input position in the cache memory; and
c) a second data pointer for maintaining the readout position from the cache memory,
d) a first circuit in electrical connection with the first data pointer for writing all bit flow data received from the test device to the cache memory; and
e) a second circuit in electrical connection with the second data pointer for writing all bit flow data stored in the cache memory to a storage device in electrical connection with the hardware disk controller.

30. The hardware disk controller of claim 29 further comprising a state machine in electrical connection with the second data pointer for programming the storage device in electrical connection with the hardware disk controller to receive bit flow data from the cache memory.

31. The hardware disk controller of claim 30 further comprising a state machine in electrical connection with the second data pointer for programming the storage device in electrical connection with the hardware disk controller to receive bit flow data from the cache memory as a sequence of words.
